(19) United States
(12) Patent Application Publication
(10) Pub. No.: US 2020/0028856 A1
(43) Pub. Date: Jan. 23, 2020

(54) PORT SCRAMBLING USAGE IN HETEROGENEOUS NETWORKS

(71) Applicant: CYBER 2.0 (2015) LTD,, Tel Aviv (IL)

(72) Inventor: EREZ KAPLAN HAELION, Rehovot (IL)

(73) Assignee: CYBER 2.0 (2015) LTD, TEL AVIV (IL)

(21) Appl. No.: 16/042,505

(22) Filed: Jul. 23, 2018

(51) Int. Cl. H04L 29/06; H04L 29/12

(52) U.S. Cl. CPC H04L 63/145; H04L 61/2015; H04L 61/2517; H04L 63/0236

(57) ABSTRACT

A method, apparatus, and computer program product for port scrambling usage in heterogeneous networks. Responsive to receiving a communication directed towards a network, wherein port scrambling and port descrambling are employed by the network, a transformation function is applied on a port at which the communication is directed to be received, whereby obtaining a scrambled port, and the communication is redirected to be received at the scrambled port. Responsive to receiving a communication from the network directed outside thereof, an inverse of the transformation function is applied on a port at which the communication is directed to be received, whereby obtaining a descrambled port, and the communication is redirected to be received at the descrambled port. Each device belonging to the network is configured for performing selective port scrambling of outgoing communications and port descrambling of incoming communications by utilizing the transformation function and inverse thereof, respectively.

### TECHNICAL FIELD

The present disclosure relates to computer network communication in general, and to port scrambling for secure network communications and usage thereof in heterogeneous networks, in particular.

### BACKGROUND

Computer networks are prevalent among many enterprises and organizations. Typically, a network environment comprises a plurality of computerized devices interconnected to one another and sharing resources, such as, for example, through common access to one or more servers connected to the network. In many cases, some or even all of the devices in the network environment are simultaneously connected also to one or more external networks, such as the World Wide Web. As a result, any of the devices in the internal network environment are made much more susceptible to various security threats and attacks, in particular the proliferation of self-propagating malicious codes, also commonly known as “viruses” or “worms”. Once a device in the network becomes compromised, the infection can spread quickly to the remaining devices, causing irreparable harm.

With the advent of network communication, a continuous increase is witnessed in both numbers and types of devices and systems provided with network connectivity and related functions, including devices and systems traditionally not provided with such capabilities. One prominent example of this trend is the Internet of Things (IoT), a concept referring to physical objects embedded with electronics, software, sensors, actuators, and the like and being able to connect to other networked devices and exchange data over a communication network such as the Internet. The physical objects may be, for example, vehicles, home appliances, wearable items, manufacturing equipment, monitoring devices, and so forth. Notwithstanding the many benefits that may be gained from IoT devices, serious concerns have been raised with respect to security issues thereof. While IoT devices may be susceptible to similar threats as conventional computers, e.g. servers, workstations, smartphones etc., due to the limited capabilities of IoT devices in comparison, security solutions such as software updates, anti-malware or firewall may not be applicable in their case.

Another example of the trend towards extended connectivity is in the realm of Operational Technology (OT), which refers to usage of computers for monitoring and controlling performance of a physical system, such as, for example, the operation of a power plant, a rail system, or the like. While historical OT networks utilized closed, proprietary protocols and security thereof relied on their standalone nature, in recent years OT systems have become linked to Information Technology (IT) systems and Internet-capable technology moved into OT systems and networks, whereby enhancing the ability of administrators to monitor and adjust their OT systems on the one hand, while introducing great challenges in securing them on the other hand. Approaches used in regular IT system require redesigning to align with OT environment or even replacement in entirety, as OT systems have different priorities and infrastructure to protect. While OT is faced with similar security concerns as IT such as malware, access control and identity management, vulnerabilities in OT systems can expose critical assets or infrastructures to great risks of sabotage and life endangerment.

### BRIEF SUMMARY

One exemplary embodiment of the disclosed subject matter is a method comprising: responsive to receiving a communication directed towards a network, wherein port scrambling and port descrambling are employed by the network, performing the steps of: applying a transformation function on a port at which the communication is directed to be received, whereby obtaining a scrambled port; and, redirecting the communication to be received at the scrambled port; and, responsive to receiving a communication from the network directed outside thereof, performing the steps of: applying an inverse of the transformation function on a port at which the communication is directed to be received, whereby obtaining a descrambled port; and, redirecting the communication to be received at the descrambled port; wherein each device belonging to the network is configured for performing selective port scrambling of outgoing communications and port descrambling of incoming communications, wherein said selective port scrambling is performed by utilizing the transformation function, wherein said port descrambling is performed by utilizing the inverse of the transformation function.

Another exemplary embodiment of the disclosed subject matter is an apparatus comprising: a network connection configured for connecting said apparatus with a network, wherein port scrambling and port descrambling are employed by the network, wherein said port scrambling is based on a transformation function, wherein said port descrambling is based on an inverse of the transformation function; a device connection configured for connecting said apparatus to a device, wherein the device is configured to communicate with devices of the network; a port scrambling module configured to receive an incoming communication directed from the device towards the network, apply said port scrambling using the transformation function and transferring the incoming communication via a scrambled port to the network; and, a port descrambling module configured to receive an outgoing communication directed from the network towards the device, apply said port descrambling using the inverse of the transformation function and transferring the outgoing communication via a descrambled port to the device.

Yet another exemplary embodiment of the disclosed subject matter is an apparatus comprising: a first network connection configured for connecting said apparatus with a first network, wherein port scrambling and port descrambling are employed by the first network, wherein said port scrambling is based on a transformation function, wherein said port descrambling is based on an inverse of the transformation function; a second network connection configured for connecting said apparatus to a second network; a port scrambling module configured to receive an incoming communication directed from the second network towards the first network, apply the port scrambling using the transformation function and transferring the incoming communication via a scrambled port to the first network; and, a port descrambling module configured to receive an outgoing communication directed from the first network towards the second network, apply the port descrambling using the inverse of the transformation function and transferring the outgoing communication via a descrambled port to the second network.

Yet another exemplary embodiment of the disclosed subject matter is a computer program product comprising a non-transitory computer readable storage medium retaining program instructions, which program instructions when read by a processor, cause the processor to perform a method comprising: responsive to receiving a communication directed towards a network, wherein port scrambling and port descrambling are employed by the network, performing the steps of: applying a transformation function on a port at which the communication is directed to be received, whereby obtaining a scrambled port; and, redirecting the communication to be received at the scrambled port; and, responsive to receiving a communication from the network directed outside thereof, performing the steps of: applying an inverse of the transformation function on a port at which the communication is directed to be received, whereby obtaining a descrambled port; and, redirecting the communication to be received at the descrambled port; wherein each device belonging to the network is configured for performing selective port scrambling of outgoing communications and port descrambling of incoming communications, wherein said selective port scrambling is performed by utilizing the transformation function, wherein said port descrambling is performed by utilizing the inverse of the transformation function.

Optionally, the network is configured for selectively performing port scrambling on the outgoing communication based on the program transmitting thereof being listed in a list of authorized programs.

Optionally, the transformation function and inverse thereof utilize one or more shared parameters retained by devices belonging to the network, wherein at least one of the shared parameters is secret.

Optionally, the network comprising a server configured for distributing to the network a list of authorized programs, wherein each device of the network is configured to utilize the list of authorized programs for determining whether to perform port scrambling, wherein the list of authorized programs is utilized by the transformation function and inverse thereof.

Optionally, the communication directed towards the network is transmitted by a device of a type selected from the group consisting of: an Internet-of-Things (IoT) device; a firewall device; and an Operational Technology (OT) device, wherein the communication from the network directed outside thereof is directed at the device.

Optionally, the communication directed towards the network is transmitted by a device comprised in a same local area network (LAN) as the network, wherein the communication from the network directed outside thereof is directed at the device.

Optionally, the communication directed towards the network is transmitted by a device, wherein the communication from the network directed outside thereof is directed at the device, wherein the device is prohibited from executing a third-party application program thereon or has limited functionality preventing from executing the third-party application program, whereby execution of a software agent for performing port scrambling is prevented.

Optionally, the apparatus is a network bridge.

Optionally, the apparatus is configured to analyze communications at a data link layer.

Optionally, the apparatus is configured to analyze communications at a network layer.

Optionally, the device is a firewall device; ports of potential malicious outgoing communications are not scrambled by the network, whereby, after said apparatus performing port descrambling thereon, a descrambled port thereof is an improper port; the firewall device is configured to drop communications directed at the improper port, without analysis of their content; whereby performance of the firewall device is improved by dropping the potential malicious outgoing communications without analysis of their content.

Optionally, the apparatus is configured to perform security analysis of the incoming communication.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1A shows a schematic illustration of a computer network, in accordance with some exemplary embodiments of the subject matter;

FIG. 1B shows a schematic illustration of a computer network in which the disclosed subject matter is used, in accordance with some exemplary embodiments of the subject matter;

FIGS. 2A-2B show block diagrams of systems, in accordance with some exemplary embodiments of the disclosed subject matter; and

FIGS. 3A-3B show flowchart diagrams of methods, in accordance with some exemplary embodiments of the disclosed subject matter.

### DETAILED DESCRIPTION

One technical problem dealt with by the disclosed subject matter is to provide for secure communication in a computer network.

Another technical problem dealt with by the disclosed subject matter is to prevent spreading of malicious code within a computer network.

Yet another technical problem dealt with by the disclosed subject matter is to allow for inclusion in a secured network of devices being either unable to or prohibited from executing third-party application programs, thus having software security solutions effectively unavailable for usage thereby. Various devices provided with network connectivity may have a limited functionality by design, due to being limited in size and/or energy supply, and as result thereof also having limited computing and storage resources. Such devices include, for example, many IoT appliances commercially available, wireless sensors, firewalls, and the like. Typically in those devices all operational logic is hard coded in their hardware or firmware and cannot be augmented by software installation or update. Additionally or alternatively, for some devices, due to critical nature of tasks or facilities entrusted therewith, it may be undesired to allow installation or running of application software thereon, even if there are no technical limitations precluding it. This may be the case, for example, in the case of OT devices and the like.

Yet another technical problem dealt with by the disclosed subject matter is to improve performance of security measures utilized in network communication, such as firewall devices or the like.

Secure communication in computer networks may be provided through use of port scrambling, such as disclosed in U.S. Pat. No. 9,838,368, entitled “PORT SCRAMBLING FOR COMPUTER NETWORKS”, issued on Dec. 5, 2017, which is hereby incorporated by reference in its entirety for all purposes without giving rise to disavowment. Port scrambling may be performed selectively for outgoing communications that are authorized, while port descrambling being performed for all ingoing communications. As a result, a descrambled port that did not originate from a scrambled, legitimate port assigned for authorized communications, is considered improper and communications received therein may be dropped without further processing and/or reported to a monitoring entity. However, a software agent implementing such port scrambling and descrambling techniques cannot be deployed on devices wherein general purpose processing is impossible or forbidden.

A “port” is a logical construct associated with a service or process residing on a computing platform and serves as an endpoint for different types of network communication. In some exemplary embodiments, a port is identified for each host address and communication protocol by a 16-bit number, thus a port number ranges from 0 to 65535. Generally, port numbers appear in network packets and map to specific processes or resources on the destination device that can handle or are expecting those packets. Some resources are preconfigured to listen to only certain predefined port numbers and ignore traffic associated with other ports. Typical network protocols that heavily rely on port numbers to map to resources include Transmission Control Protocol (TCP) and User Datagram Protocol (UDP). Some port numbers or port number ranges may be reserved for standard services, such as the “well-known ports” is ranging from 0 to 1023 used by TCP and UDP. For example, services running the Hypertext Transfer Protocol (HTTP) protocol typically listen on port 80.

One technical solution is to apply port scrambling on incoming communications directed towards a network of computerized devices in which secure communication is implemented by selectively scrambling ports of authorized communications being transmitted and descrambling ports of all communications received, and apply port descrambling on outgoing communications emanating from the network and directed to a destination outside of the network. Port scrambling of incoming communications and port descrambling of outgoing communications may be performed by a gateway apparatus being in connection with the network and to which one or more devices of a limited or restricted functionality may be connected. Each of the computerized devices of the network and the gateway apparatus may scramble and descramble ports by applying a transformation function and an inverse thereof, respectively. The transformation function and its inverse may utilize one or more shared parameters, which may be retained by the computerized devices of the network and the gateway apparatus, and which may comprise at least one secret parameter, such that mimicking the scrambling of ports by an attacker may be infeasible. The network may comprise a server, configured for distributing to devices of the network and the gateway apparatus the one or more shared parameters, which may be periodically replaced or updated so as to prevent discovery thereof by an attacker through reverse engineering of accumulated network traffic. The network may be configured to utilize a list of authorized programs for determining whether to perform port scrambling, which list may be utilized by the transformation function and inverse thereof as one of the shared parameters. The gateway apparatus may allow for any type of a limited or restricted functionality device, such as an IoT device, a firewall device, an OT device, or the like, to be connected thereto and thereby securely communicate with devices of the network. The network and the limited device may be comprised in a same local area network (LAN), such as an organizational network of a business enterprise or the like. The gateway apparatus may be a network bridge or likewise device adapted for analyzing a network communication and determining whether to forward or discard it according to its intended destination. The gateway apparatus may be configured to analyze communications either at a data link layer or at a network layer. In some exemplary embodiments, the limited device being connected to the gateway apparatus may be a firewall device being configured to drop communications directed at an improper port without further performing content analysis thereof, wherein the gateway apparatus may descramble ports of all outgoing communications, thus ports of unauthorized, potentially malicious communications that are not scrambled by the network are rendered as improper ports and, as a result, those potentially malicious communications may get discarded by the firewall device, whereby an overall amount of traffic and processing effort may be reduced. In some exemplary embodiments, the gateway apparatus may be utilized to connect the network with another network wherein port scrambling may not be employed, and allow for communication exchange between the two networks. The gateway apparatus may be further configured for performing security analysis of incoming communication directed to the network from the other network.

One technical effect of utilizing the disclosed subject matter is to allow secure communication with a device having a limited or restricted functionality precluding it from executing a software agent for port scrambling. The device may be connected to a network of computerized devices that are not subject to such limitations or restrictions and exchange communications therewith, whereby an overall secure, heterogeneous network may be formed.

Another technical effect of utilizing the disclosed subject matter is to improve filtering of network traffic, by causing unauthorized outgoing communications to be directed at improper ports and get discarded as a result. In some exemplary embodiments, such discarding may be performed without analysis of the content of the outgoing communication and may increase the processing capacity of outgoing communications, such as the processing capacity of a firewall. In some cases, improved processing capacity of the firewall may increase effective bandwidth of the network, as the firewall may process each outgoing and incoming message. In some cases, the disclosed subject matter may improve the effective upload bandwidth to and/or the effective download bandwidth from the Internet or other external networks by about 50%, about 80%, about 100% or even higher.

Yet another technical effect of utilizing the disclosed subject matter is to allow communication between a first network secured by port scrambling and a second network using different security measures or none, without compromising or relinquishing security of the first network.

It will be appreciated that the disclosed subject matter may provide for one or more technical improvements over any pre-existing technique and any technique that has previously become routine or conventional in the art. Additional technical problem, solution and effects may be apparent to a person of ordinary skill in the art in view of the present disclosure.

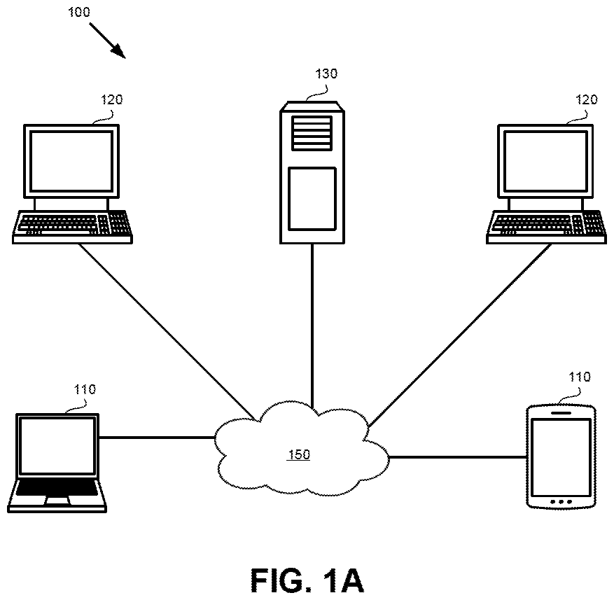

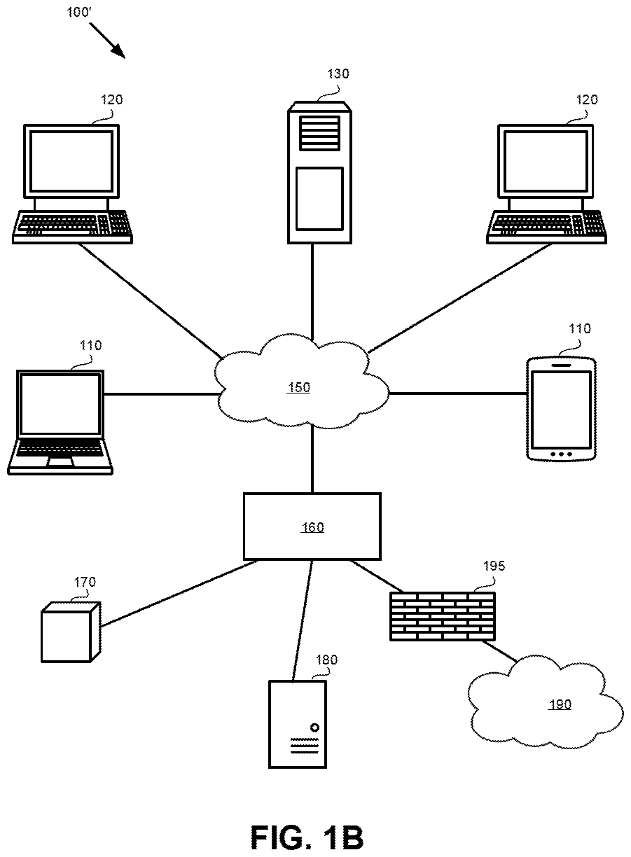

Referring now to FIG. 1A showing a schematic illustration of a computer network, in accordance with some exemplary embodiments of the disclosed subject matter.

In some exemplary embodiments, a Computer Environment 100 may comprise a plurality of computing devices, such as 110, 120 and 130, which may be connected via a Network 150. Devices 110, 120, 130 may be interconnected to one another, either by common access to a server (e.g., Server 130) or directly, such as through using a network switch, a hub, or the like.

In some exemplary embodiments, Network 150 may be an intranet network of an organization. Network 150 may be connected to an external network, such as the Internet (not shown). In some cases, Network 150 may be connected to the external network by a router, switch, server or the like, which may or may not be configured to provide some security measures to prevent malicious activity. In some exemplary embodiments, the switch may comprise a firewall for preventing access of undesired entities.

Devices 110, 120, 130 may be general purpose processing devices, such as, for example, a desktop computer, a server, a laptop computer, a tablet computer, a smartphone, or the like, being capable and permitted to execute application programs provided by third party developers, i.e. vendors other than a manufacturer of the device in question. Devices 110, 120, 130 may be either devices that are temporarily connected to Network 150, e.g. mobile devices such as Computers 110, or devices permanently connected to Network 150, e.g. desktop workstations such as Computers 120, or server computers such as Server 130.

Server 130 may be a computerized server tasked with monitoring and protecting the security of Network 150. In some exemplary embodiments, an IT professional may define an organizational policy, such as defining a whitelist of authorized programs, authorized uses of programs, a blacklist of unauthorized programs, or the like. Additionally, or alternatively, the policy may be automatically defined. Server 130 may publish and distribute the policy to computers connected to Network 150. Additionally, or alternatively, Server 130 may publish and update an encryption key to be used for security-related operation. The encryption key may be modified periodically, such as about every one second, one minute, one hour, or the like.

In some exemplary embodiments, computers connected to Network 150 may be configured to communicate using scrambled ports. Authorized outgoing communications, such as packets issued by authorized programs or under authorized conditions, may be processed and their ports may be scrambled, such as by using a transformation function. The transformation function may utilize shared parameters such as the whitelist, encryption key, or the like, so as to achieve the same results on different computers. As the encryption key may change periodically, the transformation function may yield different results for the same port at different times. The ports of unauthorized communications may not be scrambled, and these communications may be transmitted via the original ports. Additionally, or alternatively, the content of the packets may be encrypted. In some exemplary embodiments, computers connected to Network 150 may be configured to descramble the ports of any incoming communication, using an inverse function of the transformation function. Hence, ports of authorized communications may be scrambled at transmission and descrambled at reception, yielding the original port, while ports of unauthorized communications are descrambled upon receipt without having been scrambled prior thereto, and therefore get directed at a wrong port in the receiving end. In some exemplary embodiments, scrambling and descrambling may be performed by a port scrambling agent, which may be implemented in software, hardware, combination thereof, or the like.

In some exemplary embodiments, communications in a network such as Network 150 may go through a firewall. The firewall may not be configured to handle port scrambling/descrambling. In such case, the port scrambling agent may determine that the packet is directly transmitted to a firewall and avoid port scrambling of such packet. Additionally, or alternatively, a connected device receiving a packet directly from a firewall, may avoid performing port descrambling on the received packet. Similarly, the port scrambling agent may be configured to avoid scrambling when transmitting packets towards specific devices, such as sending packets towards a Voice over IP (VoIP) telephone, a printer, a network-connected time clock, or other devices which utilize the network connection but for which an agent may not be installed, e.g. an IoT device or the like. Additionally, or alternatively, the port scrambling agent may be configured to avoid descrambling ports of packets received from such devices. This course of action, however, may be disadvantageous as endpoint devices may get exposed to security risks.

Referring now to FIG. 1B showing a schematic illustration of a computer network in which the disclosed subject matter is used, in accordance with some exemplary embodiments of the disclosed subject matter.

In some exemplary embodiments, a Computer Environment 100′ may comprise a plurality of computing devices, such as 110, 120 and 130, connected via a Network 150, similarly as Computer Environment 100 of FIG. 1A. Network 150 may be connected to a Gateway Apparatus 160. Gateway Apparatus 160 may be configured to receive and process all outgoing communications transmitted from the network to an outside destination and incoming communications directed to the network. Gateway Apparatus 160 may be configured to scramble ports of incoming communications and descramble ports of outgoing communications. Gateway Apparatus 160 may utilize the same transformation function and inverse transformation function utilized by Network 150 for port scrambling and descrambling and same shared parameters utilized by the functions.

In some exemplary embodiments, Computer Environment 100′ may comprise one or more simple devices provided with network connectivity but having limited capabilities otherwise, such as IoT Device(s) 170. IoT device 170 may not be configured to execute an agent for port scrambling and descrambling, due to being lacking an operating system or likewise support for execution of third-party application programs. IoT device 170 may be connected to Gateway Apparatus 160 and exchange communications with Network 150 via Gateway Apparatus 160. Gateway Apparatus 160 may receive incoming communications directed to Network 150 from IoT device 170, scramble their ports utilizing the transformation function and forward them to Network 150 to be received via the scrambled ports. Similarly, Gateway Apparatus 160 may s receive from Network 150 outgoing communications directed to IoT device 170, descramble their ports utilizing the inverse transformation function and forward them to IoT Device 170 to be received via the descrambled ports.

In some exemplary embodiments, Computer Environment 100′ may comprise a device that may be prohibited from executing an agent for port scrambling and descrambling, such as OT Device 180. OT Device 180 may be connected to Gateway Apparatus 160 and exchange communications with Network 150 via Gateway Apparatus 160, similarly as IoT device 170. Gateway Apparatus 160 may be configured to receive incoming communications from OT Device 180 to Network 150 and outgoing communications from Network 150 to OT Device 180, scramble ports of incoming communications, descramble ports of outgoing communications, and forward the communications to their respective destination, similarly as with communications between Network 150 and IoT device 170.

It will be appreciated that secure communication between Network 150 and IoT device 170 or OT Device 180 may be provided via Gateway Apparatus 160, wherein Network 150 may employ selective port scrambling by which only ports of authorized communications are scrambled, e.g. communications transmitted by programs listed in a whitelist of authorized programs. Gateway Apparatus 160 may be configured to descramble ports of all outgoing communications sent from Network 150, thereby ports of unauthorized, potentially malicious communications that have not been scrambled prior to arrival at Gateway Apparatus 160, may be rendered improper by result of the descrambling by Gateway Apparatus 160, such that when those communications arrive at IoT device 170 or OT Device 180 they are received via improper ports and therefore not handled. Additionally, or alternatively, incoming communications to Network 150 arriving at Gateway Apparatus 160 may be processed and their ports may be selectively scrambled, if they match a security policy defined for Network 150. IoT device 170 and OT Device 180 may be connected to Gateway Apparatus 160 via wired connection, encrypted wireless connection, or the like.

In some exemplary embodiments, Gateway Apparatus 160 may be connected to one or more other networks, such as Network 190. Network 190 may be employing a regular non-secure communication protocol, or a secure communication protocol different from the port scrambling security protocol employed by Network 150, such as, for example, port scrambling utilizing different transformation function or different shared parameters. Additionally, or alternatively, Network 190 may be a public network, such as, for example, the Internet, a wide area network (WAN), or the like. Gateway Apparatus 160 may process outgoing communications from Network 150, descramble their ports and transmit the modified communications, with the descrambled ports, to Network 190. Additionally, or alternatively, incoming communications from Network 190 to Network 150 may be processed by Gateway Apparatus 160 and their ports may be scrambled and forwarded to Network 150 via the scrambled ports. In some exemplary embodiments, Gateway Apparatus 160 may be configured to perform security analysis of the incoming communications. Gateway Apparatus 160 may determine based on the security analysis whether to forward an incoming communication to Network 150 or take other actions, such as, for example, discard the communication, transfer it to a sandbox or quarantined storage, report to a server monitoring the traffic in Network 150, such as Server 130, or the like.

In some exemplary embodiments, a Firewall 195 may be deployed between Gateway Apparatus 160 and Network 190. Firewall 195 may be configured to analyze packets directed outwards towards Network 190 and packets directed inwards towards Network 150. In some exemplary embodiments, Firewall 195 may be configured to analyze the content of the packets when making its decision of whether to allow the packet to pass or not. In some cases, Firewall 195 may be configured to drop packets received at improper ports. In some exemplary embodiments, Gateway Apparatus 160 may process a packet received from Network 150 to descramble its ports. If the port of the packet was not originally scrambled, the descrambled port may be an invalid port, and Firewall 195 may drop the packet without analyzing the content of the packet. As a result, the resources of Firewall 195 may not be exhausted on analyzing packets that are deemed unauthorized by Network 150 and there may be a potentially significant increase of dozens of percentages in the bandwidth that is limited by the processing capability of Firewall 195. In some exemplary embodiments, Firewall 195 may be implemented as part of Gateway Apparatus 160.

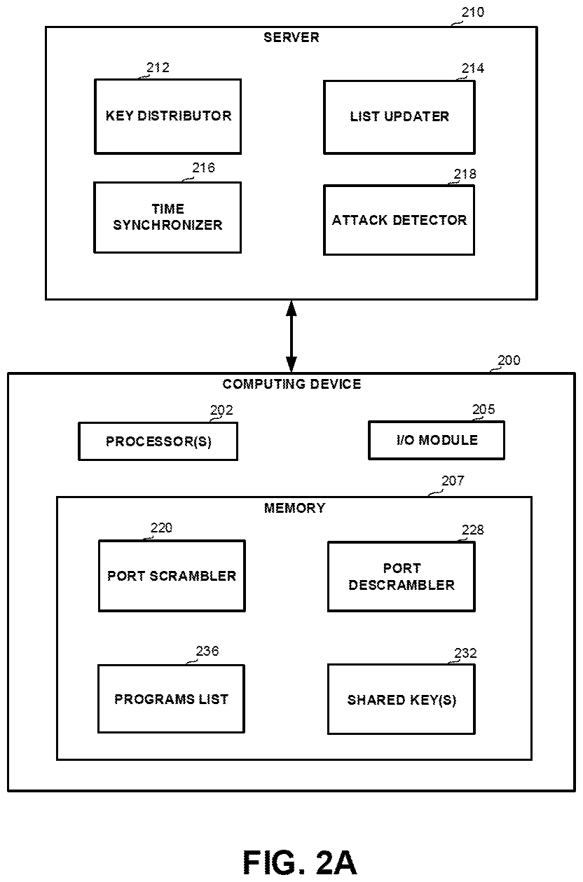

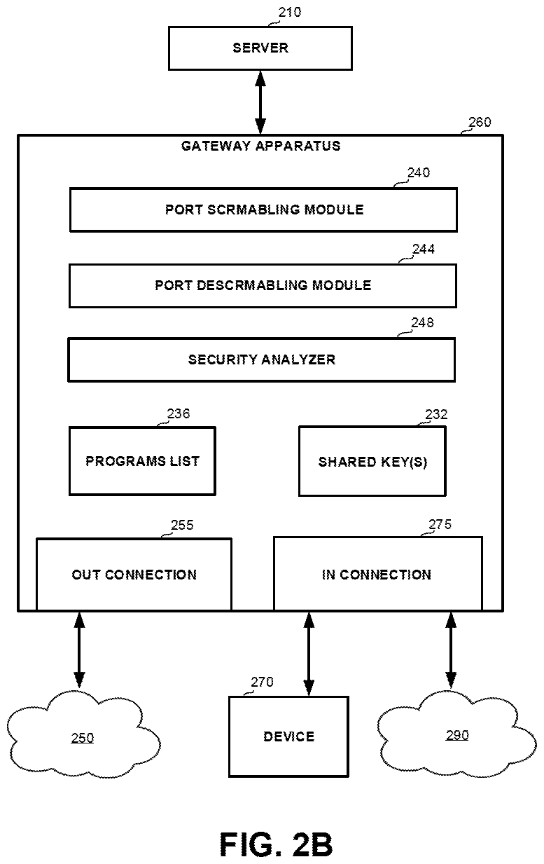

Referring now to FIG. 2A showing a block diagram of a system in accordance with some exemplary embodiments of the disclosed subject matter. The system comprises a Computing Device 200, such as 110, 120 of FIG. 1A, and may be configured to perform selective port scrambling, in accordance with the disclosed subject matter. In some exemplary embodiments, the system further comprises a Server 210, such as Server 130 of FIG. 1A, which may be in communication with Computing Device 200 via any suitable communication channel, such as an Ethernet switch connection or the like.

In some exemplary embodiments, Computing Device 200 may comprise one or more Processor(s) 202. Processor 202 may be a Central Processing Unit (CPU), a microprocessor, an electronic circuit, an Integrated Circuit (IC) or the like. Processor 202 may be utilized to perform computations required by Computing Device 200 or any of its subcomponents.

In some exemplary embodiments of the disclosed subject matter, Computing Device 200 may comprise an Input/Output (I/O) Module 205. The I/O Module 205 may be utilized to provide an output to and receive input from a user. Additionally, or Alternatively, I/O Module 205 may be utilized to provide output to and receive input from Server 210 or another Computing Device 200 in communication therewith, such as another one of Devices 110, 120 of FIG. 1A.

In some exemplary embodiments, Computing Device 200 may comprise a Memory 207. Memory 207 may be a hard disk drive, a Flash disk, a Random-Access Memory (RAM), a memory chip, or the like. In some exemplary embodiments, Memory 207 may retain program code operative to cause Processor 202 to perform acts associated with any of the subcomponents of Computing Device 200. Memory 207 may comprise one or more components as detailed below, implemented as executables, libraries, static libraries, functions, or any other executable components.

Memory 207 may comprise Port Scrambler 220 which may comprise or be in communication with a Programs List 236 and one or more Shared Key(s) 232. Port Scrambler 220 may be configured to selectively apply a port scrambling function on port numbers associated with outgoing communications. Port Scrambler 220 may apply the port scrambling function responsive to receiving a request to transmit an outgoing communication from an application program listed on Programs List 236 (and executed by Computing Device 200). Port Scrambler 220 may use Shared Key(s) 232 as a parameter of the port scrambling function. Port Scrambler 220 may obtain a scrambled port number by applying the port scrambling function on the port number identifying the destination of the outgoing communication. Port Scrambler 220 may direct the outgoing communication to a destination identified by the scrambled port number.

Memory 207 may comprise Port Descrambler 228 which may comprise or be in communication with Shared Key(s) 232. Port Descrambler 228 may be configured to apply a port descrambling function on port numbers associated with incoming communications to Computing Device 200. The port descrambling function may be an inverse function of the port scrambling function applied by Port Scrambler 220. Port Descrambler 228 may use Shared Key(s) 232 as a parameter of the port descrambling function. Port Descrambler 228 may receive an incoming communication at a port identified by a scrambled port number. Port Descrambler 228 may obtain a descrambled port number (e.g., original port number) by applying the port descrambling function on the scrambled port number. In some exemplary embodiments, Port Descrambler 228 may perform the descrambling on all incoming communications regardless of their origin. Port Descrambler 228 may redirect the incoming communication to a port identified by the descrambled port number. Port Descrambler 228 may issue a notification to Server 210 in case that the descrambled port number is not assigned to any application program currently executing on Computing Device 200.

Similarly to Computing Device 200, Server 210 may comprise Processor(s) (not shown), I/O Module (not shown) and Memory (not shown).

Server 210 may comprise a Key Distributor 212 for generating and distributing Shared Key(s) 232 among a plurality of computing devices, such as Computing Device 200, in a computer network environment such as Computer Environment 100 of FIG. 1A. Key Distributor 212 may distribute Shared Key 232 to Computing Device 200 using Public Key Infrastructure (PKI) cryptography. Shared Key 232 may comprise a fixed encryption key. Additionally or alternatively, Shared Key 232 may comprise a time-dependent encryption key, replaced periodically and valid for a limited time duration. In some exemplary embodiments, Shared Key(s) 232 may comprise three keys: a time dependent key that is updated periodically, a fixed key that uniquely identifies the organization in which the system of FIG. 2A is deployed, and a key which depends on s Programs List 236, such as a hashing of Programs List 236.

Server 210 may comprise a List Updater 214 for maintaining and updating Programs List 236 among the plurality of computing devices in the network environment. List Updater 214 may provide credentials enabling verification of the content of Programs List 236 by Computing Device 200, for example by applying a hash function on Programs List 236 and digitally signing the result. The credentials may also be used for the scrambling or descrambling process, as one of the Shared Key(s) 232 that is distributed by Key Distributor 212.

Server 210 may comprise a Time Synchronizer 216 for synchronizing system clocks among the plurality of computing devices in the network environment, in case that one or more of the Shared Key(s) 232 distributed by Key Distributor 212 are time-dependent.

Server 210 may comprise an Attack Detector 218, configured for tracking and analyzing traffic in the computer network environment in order to detect possible security attacks and outbreaks. Attack Detector 218 may receive and analyze notifications from Computing Device 200 concerning incoming communications for which the descrambled port number is not assigned to an application program.

In some exemplary embodiments, Key Distributor 212, List Updater 214, Time Synchronizer 216 and Attack Detector 218 may be deployed on one or more separate servers. In one embodiment, each of the above is deployed on a stand-alone and separate server.

In some exemplary embodiments, Server 210 may monitor communication in the network, identify transmission to invalid ports, analyze such transmission to detect potential malicious activity and mitigate risk from such activities. In some exemplary embodiments, the disclosed subject matter may utilize a server such as disclosed in U.S. Pat. No. 9,794,277, entitled “MONITORING TRAFFIC IN A COMPUTER NETWORK”, issued on Oct. 17, 2017, which is hereby incorporated by reference in its entirety for all purposes without giving rise to disavowment.

Referring now to FIG. 2B showing a block diagram of a system, in accordance with some exemplary embodiments of the disclosed subject matter.

Gateway Apparatus 260 may be an apparatus configured to receive and process communications sent by or towards computerized devices equipped with network connectivity, similarly as 160 of FIG. 1B. Gateway Apparatus 260 may comprise Processor(s) (not shown), I/O Module (not shown) and Memory (not shown). Gateway Apparatus 260 may comprise an Out Connection 255 configured to connect Gateway Apparatus 260 with a network, such as Network 250. Gateway Apparatus 260 may receive via Out Connection 255 any and all outgoing communications transmitted from Network 250 towards a destination outside of Network 250. Gateway Apparatus 260 may comprise an In Connection 275 configured to connect Gateway Apparatus 260 with a device provided with network connectivity, such as Device 270. Additionally or alternatively, In Connection 275 may be configured to connect Gateway Apparatus 260 with another network, different than the network connected with Gateway Apparatus 260 via Out Connection 255, such as Network 290. Gateway Apparatus 260 may receive via In Connection 275 all ingoing communications sent to Network 250 from Device 270 and/or from Network 290.

Network 250 may be a secure network wherein secure communication is effected by means of port scrambling and descrambling, in accordance with some exemplary embodiments of the disclosed subject matter. Device 270 may be a device unable to or prohibited from executing a port scrambling/descrambling agent, such as IoT Device 170 or OT Device 180 of FIG. 1B, a firewall, or the like. In some exemplary embodiments, Network 290 may be a public, non-secure network, such as the Internet or the like. Alternatively, Network 290 may be a secure network employing a different port scrambling protocol than Network 250, e.g. by utilizing different parameters or the like.

Gateway Apparatus 260 may comprise a Port Scrambling Module 240, configured to scramble ports of incoming communications to Network 250 received via In Connection 275, and a Port Descrambling Module 244, configured to descramble ports of outgoing communications from Network 250 received via Out Connection 255. Gateway Apparatus 260 may be configured to retain Shared Key(s) 232 and Program List 236 for use by Port Scrambling Module 240 and Port Descrambling Module 244, similarly as Computing Device 200 and its subcomponents Port Scrambler 220 and Port Descrambler 228. In some exemplary embodiments, Program List 236 may be utilized as a parameter of the transformation and inverse transformation functions used for scrambling and descrambling ports. Gateway Apparatus 260 may receive Shared Key(s) 232 and Program List 236 from a Server 210. Server 210 may be configured to update and distribute Shared Key(s) 232 and Program List 236 to Gateway Apparatus 260 and computerized devices belonging to Network 250, similarly as in FIG. 2A.

In some exemplary embodiments, Gateway Apparatus 260 may comprise a Security Analyzer 248. Gateway Apparatus 260 may use Security Analyzer 248 to process incoming communications received via In Connection 275 and determine whether they are compliant with a security policy defined for Network 250. Based on a determination by Security Analyzer 248, Gateway Apparatus 260 may selectively apply Port Scrambling Module 240 on incoming communications, such that only ports of vetted communications are scrambled prior to being forwarded to Network 250.

In some exemplary embodiments, Gateway Apparatus 260 may be configured to process incoming and outgoing communications either at a data link layer, i.e., layer 2 in the seven layer Open Systems Interconnection (OSI) model, or at a network layer, i.e. layer 3 in the OSI model. It will be appreciated that in case Gateway Apparatus 260 is employed at a network layer, a different IP address may be assigned for Device 270 so that communications sent to Device 270 may be routed to Gateway Apparatus 260. It will be appreciated that Gateway Apparatus 260 when employed at the network layer may be utilized as a firewall, whereby communications from a source outside Network 250 and different from Device 270 may be blocked, or selectively forwarded to Network 250 based on being sent in response to request coming from Network 250.

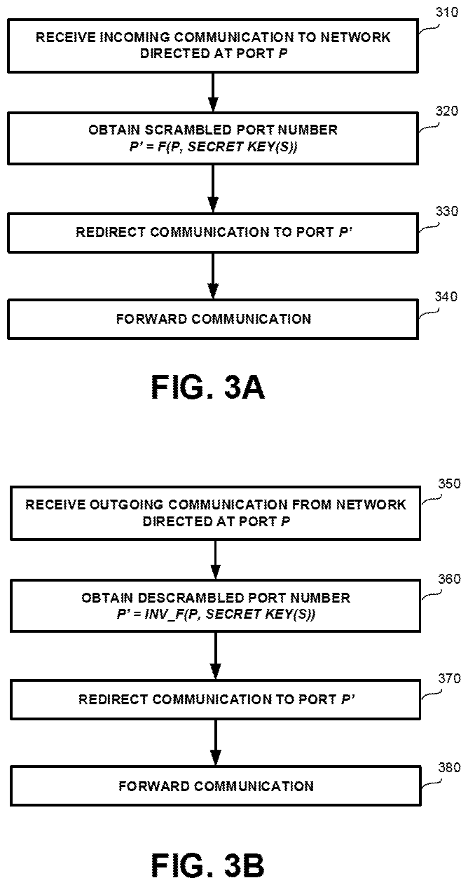

Referring now to FIG. 3A showing a flowchart diagram of method, in accordance with some exemplary embodiments of the disclosed subject matter.

On Step 310, an incoming communication directed to a network via a first port (denoted as P), may be received. For example, the incoming communication may be a UDP packet provided with an IP address of a computerized device in the network and a port number, e.g. 192.168.1.52:80. The incoming communication may be sent by a device precluded from executing a port scrambling agent, such as Device 270 of FIG. 2B, or by a device of a different network.

On Step 320, a transformation function may be applied on an identifier of the first port to obtain an identifier of a second port (denoted as P′). The transformation function may depend on at least one secret parameter shared among a plurality of computing devices in a computer network, such as Shared Key 232 of FIG. 2A. The identifier of the first port may be obtainable by applying an inverse transformation on the identifier of the second port. The inverse transformation may depend on the at least one secret parameter, such that only devices sharing the at least one secret parameter may be able to apply the inverse transformation. The transformation function may be either a symmetric cryptography function, such as DES, AES, or the like, or an asymmetric cryptography function, such as RSA, El-Gammal, or the like.

In some exemplary embodiments, the scrambled port number may not be a port number which has a general known functionality, such as port numbers known as “common port numbers” which are published by the Internet Assigned Number Authority (IANA) or the like. As an example, the scrambled port may not be port 20-21 (used for FTP), port 22 (used for SSH), port 53 (used for DNS), port 80 (used for HTTP), port 443(used for HTTPS) or the like. In case the transformation function provides an excluded port, a next non-excluded port may be selected on Step 320. Additionally, or alternatively, a list of excluded ports may include common port numbers or other port numbers which are constantly excluded. The list may also include port numbers which were used as scrambled ports in a previous time segment. For example, in case port 80 was scrambled to port 1579 during a first time segment, in a next time segment, when port 80 is scrambled to a different port number, all other ports may be excluded from being scrambled to port 1579 so as to avoid collision and confusion. In such an embodiment, a packet that is destined to port 1579 and is received in the second segment may be uniquely identified as a packet that was transmitted during the first time segment towards port 80.

On Step 330, the incoming communication may be redirected to be transmitted via the second port. In the above given example in which the original address is 192.168.1.52:80 and in which port 80 is scrambled to port 1579, the outgoing communication may be transmitted to 192.168.1.52:1579. In some exemplary embodiments, a security analysis step (not shown) may be performed on the incoming communication prior to Steps 320 and 330, to determine whether the incoming communication is in line with a security policy defined for the network, and if not, the s method may either skip Steps 320 to 330 and resume at Step 340 or stop and take no further action.

On Step 340, the incoming communication may be forwarded to the network, either via the original port P or the scrambled port depending on whether the port was scrambled or not.

Referring now to FIG. 3B showing a flowchart diagram of method, in accordance with some exemplary embodiments of the disclosed subject matter.

On Step 350, an outgoing communication from a network, directed to be received via a first port at a destination outside of the network, may be received. The outgoing communication may be received from a device of the network such as Computing Device 200 of FIG. 2A, whereby selective port scrambling may be performed. The destination may be a limited or restricted functionality device, such as Device 270, or a device of a different network, configured to connect and communicate with the network via an apparatus such as Gateway Apparatus 260 of FIG. 2B.

On Step 360, an identifier of a second port may be obtained by applying an inverse transformation function on an identifier of the first port. The inverse transformation function may depend on at least one secret parameter shared among a plurality of computing devices in the computer network, such as Shared Key 232 of FIG. 2A.

On Step 370, the outgoing communication may be redirected to the second port. It will be appreciated that, in case the outgoing communication is an authorized communication, the first port may be a scrambled version of a port at which the outgoing communication was originally directed, and the second port may be identical to the original port. Otherwise the first port may be identical to the original port and the second port may be a descrambled version of the original port, which may be an improper port, causing communications received therein to be discarded.

On Step 380, the outgoing communication may be forwarded to be received at its destination via the descrambled port P′.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not s preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
responsive to receiving a communication directed towards a network, wherein port scrambling and port descrambling are employed by the network, performing the steps of:
applying a transformation function on a port at which the communication is directed to be received, whereby obtaining a scrambled port; and,
redirecting the communication to be received at the scrambled port; and,
responsive to receiving a communication from the network directed outside thereof, performing the steps of:
applying an inverse of the transformation function on a port at which the communication is directed to be received, whereby obtaining a descrambled port; and,
redirecting the communication to be received at the descrambled port;
wherein each device belonging to the network is configured for performing selective port scrambling of outgoing communications and port descrambling of incoming communications, wherein said selective port scrambling is performed by utilizing the transformation function, wherein said port descrambling is performed by utilizing the inverse of the transformation function.

2. The method of claim 1, wherein the network is configured for selectively performing port scrambling on the outgoing communication based on the program transmitting thereof being listed in a list of authorized programs.

3. The method of claim 1, wherein the transformation function and inverse thereof utilize one or more shared parameters retained by devices belonging to the network, wherein at least one of the shared parameters is secret.

4. The method of claim 1, wherein the network comprising a server configured for distributing to the network a list of authorized programs, wherein each device of the network is configured to utilize the list of authorized programs for determining whether to perform port scrambling, wherein the list of authorized programs is utilized by the transformation function and inverse thereof.

5. The method of claim 1, wherein the communication directed towards the network is transmitted by a device of a type selected from the group consisting of: an Internet-of-Things (IoT) device; a firewall device; and an Operational Technology (OT) device, wherein the communication from the network directed outside thereof is directed at the device.

6. The method of claim 1, wherein the communication directed towards the network is transmitted by a device comprised in a same local area network (LAN) as the network, wherein the communication from the network directed outside thereof is directed at the device.

7. The method of claim 1, wherein the communication directed towards the network is transmitted by a device, wherein the communication from the network directed outside thereof is directed at the device, wherein the device is prohibited from executing a third-party application program thereon or has limited functionality preventing from executing the third-party application program, whereby execution of a software agent for performing port scrambling is prevented.

8. An apparatus comprising:
a network connection configured for connecting said apparatus with a network, wherein port scrambling and port descrambling are employed by the network, wherein said port scrambling is based on a transformation function, wherein said port descrambling is based on an inverse of the transformation function;
a device connection configured for connecting said apparatus to a device, wherein the device is configured to communicate with devices of the network;
a port scrambling module configured to receive an incoming communication directed from the device towards the network, apply said port scrambling using the transformation function and transferring the incoming communication via a scrambled port to the network; and,
a port descrambling module configured to receive an outgoing communication directed from the network towards the device, apply said port descrambling using the inverse of the transformation function and transferring the outgoing communication via a descrambled port to the device.

9. The apparatus of claim 8, wherein devices in the network are configured for selectively performing port scrambling on the outgoing communication based on a program transmitting thereof being listed in a list of authorized programs, wherein the devices are configured to perform port descrambling on all incoming communications received thereby.

10. The apparatus of claim 8, wherein the network comprising a server configured for distributing to the network and to said apparatus a list of authorized programs, wherein devices of the network are configured to utilize the list of authorized programs for determining whether to perform port scrambling, wherein the list of authorized programs is utilized by the transformation function and inverse thereof.

11. The apparatus of claim 8, wherein the device is of a type selected from the group consisting of: an Internet-of-Things (IoT) device; a firewall device; and an Operational Technology (OT) device.

12. The apparatus of claim 8, wherein the device is comprised in a same local area network (LAN) as the network.

13. The apparatus of claim 8, wherein the device is prohibited from executing a third-party application program thereon or has limited functionality preventing from executing the third-party application program, whereby execution of a software agent for performing port scrambling is prevented.

14. The apparatus of claim 8, wherein said apparatus is a network bridge.

15. The apparatus of claim 8, wherein said apparatus is configured to analyze communications at a data link layer.

16. The apparatus of claim 8, wherein said apparatus is configured to analyze communications at a network layer.

17. The apparatus of claim 8,
wherein the device is a firewall device;
wherein ports of potential malicious outgoing communications are not scrambled by the network, whereby, after said apparatus performing port descrambling thereon, a descrambled port thereof is an improper port;
wherein the firewall device is configured to drop communications directed at the improper port, without analysis of their content;
whereby performance of the firewall device is improved by dropping the potential malicious outgoing communications without analysis of their content.

18. An apparatus comprising:
a first network connection configured for connecting said apparatus with a first network, wherein port scrambling and port descrambling are employed by the first network, wherein said port scrambling is based on a transformation function, wherein said port descrambling is based on an inverse of the transformation function;
a second network connection configured for connecting said apparatus to a second network;
a port scrambling module configured to receive an incoming communication directed from the second network towards the first network, apply the port scrambling using the transformation function and transferring the incoming communication via a scrambled port to the first network; and,
a port descrambling module configured to receive an outgoing communication directed from the first network towards the second network, apply the port descrambling using the inverse of the transformation function and transferring the outgoing communication via a descrambled port to the second network.

19. The apparatus of claim 18, wherein said apparatus is configured to perform security analysis of the incoming communication.

20. A computer program product comprising a non-transitory computer readable storage medium retaining program instructions, which program instructions when read by a processor, cause the processor to perform a method comprising:
responsive to receiving a communication directed towards a network, wherein port scrambling and port descrambling are employed by the network, performing the steps of:
applying a transformation function on a port at which the communication is directed to be received, whereby obtaining a scrambled port; and,
redirecting the communication to be received at the scrambled port; and,
responsive to receiving a communication from the network directed outside thereof, performing the steps of:
applying an inverse of the transformation function on a port at which the communication is directed to be received, whereby obtaining a descrambled port; and,
redirecting the communication to be received at the descrambled port;
wherein each device belonging to the network is configured for performing selective port scrambling of outgoing communications and port descrambling of incoming communications, wherein said selective port scrambling is performed by utilizing the transformation function, wherein said port descrambling is performed by utilizing the inverse of the transformation function.
